(19) United States
(12) Patent Application Publication
(10) Pub. No.: US 2026/0095694 A1
(43) Pub. Date: Apr. 2, 2026

(54) SOUND GUIDING AND REVERBERATION COMPONENT FOR REAR LOUDSPEAKER OF BLUETOOTH EARPHONE

(71) Applicant: Hong Li, Guang'an (CN)

(72) Inventor: Hong Li, Guang'an (CN)

(21) Appl. No.: 19/411,696

(22) Filed: Dec. 8, 2025

(30) Foreign Application Priority Data
Dec. 9, 2024 (CN) 202423029534.5

(51) Int. Cl. H04R 1/34; H04R 1/10; H04R 1/28

(52) U.S. Cl. CPC H04R 1/345; H04R 1/1008; H04R 1/1025; H04R 1/105; H04R 1/1075; H04R 1/2811; H04R 2420/07

(57) ABSTRACT

The present disclosure discloses a sound guiding and reverberation component for a rear loudspeaker of a Bluetooth earphone. A sound guiding and reverberation component penetrating through the entire housing and a through sound transmission channel are disposed at a front position of a Bluetooth earphone body; a sealed cavity is disposed in a space between a position below a rear position of a mainboard, the sound guiding and reverberation component, and a back shell, and a loudspeaker is located in the sealed cavity; the sealed cavity forces original sound waves emitted by the loudspeaker to flow only from the sound outlet holes to mix with the flowing air within the channel, causing the original sound waves to superimpose multiple times to form reverberated sound waves.

### CROSS-REFERENCE TO RELATED APPLICATIONS

This application claims priority to Chinese Patent Application No. 202423029534.5, filed on Dec. 9, 2024, which is hereby incorporated by reference in its entirety.

### TECHNICAL FIELD

The present disclosure relates to Bluetooth earphones, in particular to a sound guiding and reverberation component for a rear loudspeaker of a Bluetooth earphone.

### BACKGROUND

A Bluetooth earphone is a compact electronic device that wirelessly connects to a mobile phone for audio input and output, offering great convenience to users. In modern life, it is often carried around for personal use. When worn, the position directly facing the ear canal of the user is referred to as the front position, whereas the position facing the auricle above or lateral to the ear canal is referred to as the rear position.

In currently available Bluetooth earphones, an internal loudspeaker and a mainboard are provided. The loudspeaker is invariably positioned at the front position of the mainboard and is electrically connected to it. This configuration means that when worn, the loudspeaker directly faces directly the ear canal of the user. The mainboard controls the loudspeaker to produce sound, and the acoustic waves are directly transmitted into the ear canal, allowing the user to hear the audio output. However, the configuration of front-positioned loudspeaker suffers from drawbacks:
1. When worn by the user, the loudspeaker directly faces the ear canal of the user, which requires that the surface cover must fully enclose the opening of the ear canal. Consequently, the original sound waves produced by the loudspeaker enter the ear canal directly, preventing the formation of reverberant sound waves;
2. The surface cover's complete enclosure of the ear canal provides effective sound isolation from the external environment, allowing sound waves to enter the ear canal entirely. However, such configuration also makes the opening of the ear canal airtight, restricting airflow. Prolonged wearing can lead to bacterial growth, resulting in redness or swelling. In severe cases, it may cause otitis media and tinnitus.

Many users nowadays prefer wearing earphones while walking. However, this habit carries significant risks. For instance, when crossing a street, the effective sound isolation makes it difficult for external sounds (such as car horns) to pass through the earphones and reach the ear canal. This inability to perceive ambient hazards creates substantial safety concerns
2. The cover of Bluetooth earphones completely covers the ear canal opening, which provides good sound insulation and allows all sound waves to enter the ear canal. However, this makes the ear canal opening poorly ventilated and air circulation restricted. Over time, bacteria can easily grow at the ear canal opening, causing redness/swelling. In severe cases, it can lead to eardrum inflammation and tinnitus;
3. Many users like to wear earphones while walking and listen to music, but this poses a great risk. For example, when crossing the road, due to the good sound insulation, external sounds (such as vehicle horns) are difficult to enter the ear canal through the earphones, making it impossible to avoid danger and causing great safety hazards.

The present disclosure disclosed herein is a new development based on the existing technology.

### SUMMARY

The present disclosure provides a sound guiding and reverberation component for a rear loudspeaker of a Bluetooth earphone, aiming to solve the defects in the prior art.

The present disclosure adopts the following solution.

The present disclosure provides a sound guiding and reverberation component for a rear loudspeaker of a Bluetooth earphone, comprising a Bluetooth earphone body, a mainboard, a sound guiding and reverberation component, and a loudspeaker being provided inside a housing of the Bluetooth earphone body; wherein the sound guiding and reverberation component penetrates through a first circular through hole in a front position of the mainboard and is disposed at a front position of the Bluetooth earphone body in a penetration manner, the sound guiding and reverberation component is provided with an internally hollow and communicated sound transmission channel, the sound transmission channel located on a side of a back shell of the housing is provided with annularly arranged sound outlet holes which are evenly distributed in a ring shape; a sealed cavity is formed in a space between the sound guiding and reverberation component and a position below a rear position of the mainboard and the back shell; the loudspeaker is located in the sealed cavity and electrically connected to the mainboard; in a wearing state, the sound outlet holes of the sound guiding and reverberation component located at the front position of the Bluetooth earphone body surround an opening of an ear canal, the sound transmission channel located in the middle directly faces the opening of the ear canal, and the loudspeaker located at a rear position of the Bluetooth earphone body is located at an auricle above the opening of the ear canal.

The sound guiding and reverberation component includes a sound conducting component, a sealing connector, and a sound guiding upper cover.

The sound conducting component is a first hollow cylinder with a hollow interior, a lower end surface of the first hollow cylinder is set as a first arc-shaped opening, a platform surface protrudes around a back surface of the first arc-shaped opening, a plurality of sound outlet holes arranged in a ring shape evenly penetrating through the first arc-shaped opening are disposed on the platform surface, an outer end surface of the sound outlet holes is located on an arc surface of the first arc-shaped opening and set in an arc shape; an upper end of the first hollow cylinder is provided with a first inwardly inclined locking position.

The sealing connector is a hollow cylindrical connecting groove, a baffle is provided at a lower end of the connecting groove, and a C-shaped opening is provided on one side of the baffle, corresponding through holes are provided on two sides of the C-shaped opening, and a first step protruding upward in a full circle is provided on an inner wall of the connecting groove.

The sound guiding upper cover is a second hollow cylinder with a hollow interior, an upper end surface of the second hollow cylinder is set as a second arc-shaped opening, and a back surface of the second arc-shaped opening is provided with a locking edge protruding in a full circle; and a second step protruding downward is provided in a cylinder at a lower end of the sound guiding upper cover.

The first circular through hole penetrating through the front position of the mainboard and located at the lower end of the second hollow cylinder of the sound guiding upper cover extends into the connecting groove of the sealing connector, a lower bottom edge of the sound guiding upper cover abuts against the first step on the inner wall of the connecting groove, a charging post of the mainboard penetrates through a through hole) of the baffle of the sealing connector; an upper end of the first hollow cylinder of the sound guiding component is inserted into the connecting groove of the sealing connector until the first locking position abutting against the second step of the sound guiding upper cover; a gap with a certain distance is reserved between the baffle and the platform surface; the sound conducting component, the sealing connector, and the sound guiding upper cover are connected to form the sound guiding and reverberation component, wherein the first hollow cylinder, the connecting groove, and the interior of the second hollow cylinder are connected to form the sound transmission channel.

The housing includes a surface cover and the back shell, a front position of the surface cover and a front position of the back shell are respectively provided with a corresponding second circular through hole which directly faces the first circular through hole provided on the front position of the mainboard; the mainboard is assembled in the back shell of the housing; the locking edge of the sound guiding upper cover abuts against an inner edge of a second circular through hole of the surface cover, and the second arc-shaped opening is located at the second circular through hole of the surface cover; an outer edge of a lower end surface of the platform surface of the sound conducting component abuts against an inner edge of a second circular through hole of the back shell, the sound outlet holes located on the first arc-shaped opening are located at the second circular through hole of the back shell; the sealed cavity is formed in the space between the sound guiding and reverberation component and the position below the rear position of the mainboard and the back shell, the loudspeaker is located in the sealed cavity, and an edge of the loudspeaker is inserted into the C-shaped opening of the sealing connector and tightly attached.

Preferably, the mainboard is provided with preset operation programs and electronic components.

Preferably, the back shell is provided with two small through holes which directly face the through holes of the baffle, and the charging post on the mainboard extends out; the back shell is provided with a locking post configured to fix the mainboard during mounting; the back shell and the surface cover are provided with corresponding locking positions configured to fix the back shell and the surface cover in the locking positions.

Preferably, the housing is connected to a battery terminal through a flexible rubber ear hook, the battery terminal is provided with a battery, and the battery is electrically connected to the mainboard through a connecting wire in the flexible rubber ear hook.

Preferably, an air inlet is provided on one side of the surface cover of the housing, and microphone pickup holes are provided on two sides, respectively.

The beneficial effects of the present disclosure are as follows: the sound guiding and reverberation component penetrating through the entire housing and the through sound transmission channel are disposed at the front position of the Bluetooth earphone body; the sealed cavity is disposed in the space between the position below the rear position of the mainboard, the sound guiding and reverberation component, and the back shell, and the loudspeaker is located in the sealed cavity; when worn by the user, sound outlet holes arranged in a ring shape of the sound guiding and reverberation component surround the opening of the ear canal, the sound transmission channel directly faces the opening of the ear canal, and the loudspeaker is located on the auricle above the opening of the ear canal; during operation, the sealed cavity forces original sound waves emitted by the loudspeaker to flow only from the sound outlet holes, allowing them to reflect and propagate multiple times within the sound transmission channel, mixing with the flowing air within the channel, causing the original sound waves to superimpose multiple times to form reverberated sound waves, and resulting in better sound quality and better user experience; the through sound transmission channel ensures good ventilation at the opening of the ear canal while allowing the user to hear external sound; the sound guiding and reverberation component has a simple structure, all components can be mass-produced by molding, and mounting is simple.

### BRIEF DESCRIPTION OF THE DRAWINGS

FIG. 1 is a schematic diagram of a back shell of a Bluetooth earphone body according to the present disclosure;

FIG. 2 is an exploded view of a Bluetooth earphone body according to the present disclosure;

FIG. 3 is a schematic diagram of connection of a sound guiding and reverberation component according to the present disclosure;

FIG. 4 is a cross-sectional view according to the present disclosure;

FIG. 5 is an exploded view of a sound guiding and reverberation component from another angle according to the present disclosure;

FIG. 6 is a diagram showing correspondence between a sound guiding and reverberation component and a housing according to the present disclosure;

FIG. 7 is a schematic diagram of a cover of a Bluetooth earphone body according to the present disclosure.

Reference signs in the figures: 100—Bluetooth earphone body, 100-1—front position, 100-2—rear position, 103—sealed cavity, 10—housing, 11—surface cover, 111—air inlet, 112—microphone pickup hole, 12—back shell, c—second circular through hole, 11-c—second surface cover circular through hole, 12-c—second back shell circular through hole, d—small through hole, 121—locking post, 122—locking position, 20—mainboard, 20-1—front position, 20-2—rear position, a-second circular through hole, 23—charging post, 30—gound guiding and reverberation component, 31—sound conducting component, 311—first hollow cylinder, 3111—first locking position, 312—first arc-shaped opening, 313—platform surface, 314—sound outlet hole, 32—sealing connector, 321—connecting groove, 3211—first step, 322—baffle, 3221-C—shaped opening, c—through hole, 323—gap, 33—sound guiding upper cover, 331—second hollow cylinder, 3311—second step, 332—second arc-shaped opening, 333—locking edge, 34—sound transmission channel, 40—loudspeaker, 50—flexible rubber ear hook, 60—battery terminal, 61—battery, → indicates a direction of sound wave transmission.

### DESCRIPTION OF EMBODIMENTS

The technical solutions of the present disclosure will be clearly and completely described below with reference to the accompanying drawings of the embodiments. Obviously, the described embodiments are only some embodiments of the present disclosure, but not all embodiments. All other embodiments obtained by those having ordinary skills in the art without creative effort based on the embodiments of the present disclosure are within the protection scope of the present disclosure.

It should be noted that all directional indicators (e.g., up, down, left, right, front, back, etc.) in the embodiments of the present disclosure are only used to explain the relative positional relationship and movement of each component in a certain specific posture (as shown in the figure). If the specific posture changes, the directional indicator will also change accordingly.

Furthermore, the terms “first” and “second” are used for descriptive purposes only and should not be construed as indicating or implying relative importance, or implicitly specifying the number of technical features indicated. Thus, a feature defined as “first” or “second” may explicitly or implicitly include one or more of that feature. In the description of the present disclosure, “multiple” means two or more, unless otherwise explicitly specified.

In the present disclosure, unless otherwise explicitly specified and limited, the terms “connection,” “fixing,” “installation,” etc., should be interpreted broadly. For example, “fixing” can mean a fixed connection, a detachable connection, or an integral connection; it can mean a mechanical connection or an electrical connection; it can mean a direct connection or an indirect connection through an intermediate medium; it can mean the internal communication of two components or the interaction between two components, unless otherwise explicitly limited. Those skilled in the art can understand the specific meaning of the above terms in the present disclosure according to the specific circumstances.

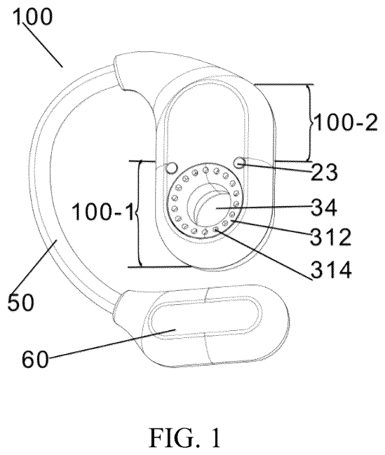

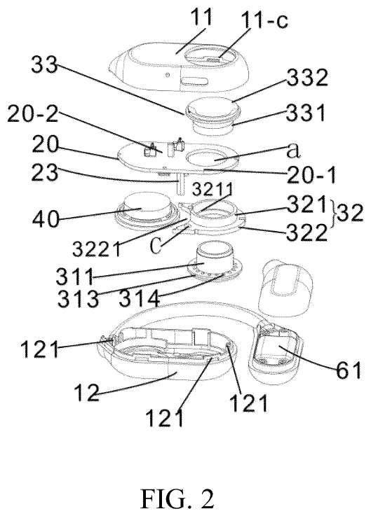

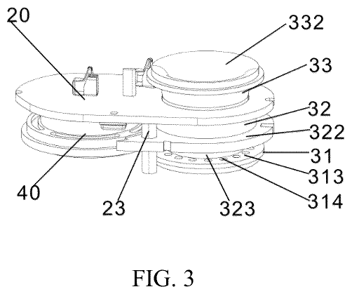

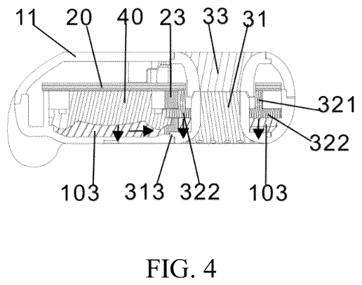

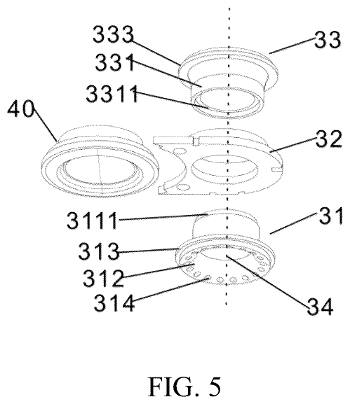

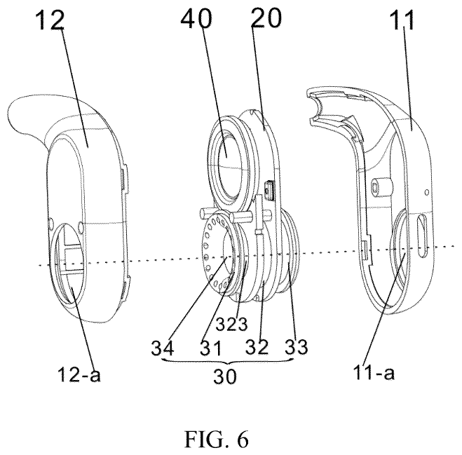

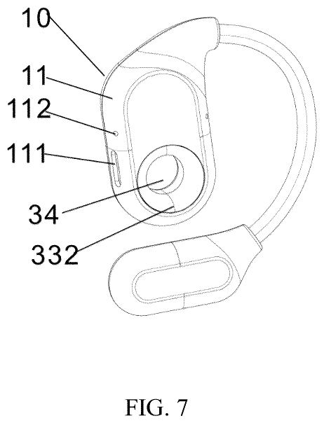

Referring to FIGS. 1-7, a sound guiding and reverberation component for a rear loudspeaker of a Bluetooth earphone includes a Bluetooth earphone body (100), and a mainboard (20), a sound guiding and reverberation component (30), and a loudspeaker (40) are provided inside a housing (10) of the Bluetooth earphone body (100); the sound guiding and reverberation component (30) penetrates through a first circular through hole (a) in a front position (20-1) of the mainboard (20) and is disposed at a front position (100-1) of the Bluetooth earphone body (100) in a penetration manner, the sound guiding and reverberation component (30) is provided with an internally hollow and a sound transmission channel (34) communicated through the Bluetooth earphone body (100), and the sound transmission channel (34) located on a side of a back shell (12) of the housing (10) is provided with annularly arranged sound outlet holes (314) which are evenly distributed in a ring shape; a sealed cavity (103) is formed in a space between the sound guiding and reverberation component (30) and a position below a rear position (20-2) of the mainboard (20) and the back shell (12); the loudspeaker (40) is located in the sealed cavity (103) and electrically connected to the mainboard (20); in a wearing state, the sound outlet holes (314) of the sound guiding and reverberation component (30) located at the front position (100-1) of the Bluetooth earphone body (100) surround an opening of an ear canal, the sound transmission channel (34) located in the middle directly faces the opening of the ear canal, and the loudspeaker (40) located at a rear position (100-2) of the Bluetooth earphone body (100) is located at an auricle above the opening of the ear canal.

The connection of the sound guiding and reverberation component (30) of the present disclosure;

The sound guiding and reverberation component (30) includes a sound conducting component (31), a sealing connector (32), and a sound guiding upper cover (33);

A cylinder of a lower end of a sound guiding upper cover (33) penetrates through a through hole (a) at the front position (20-1) of the mainboard (20) and extends into a connecting groove (321) of a sealing connector (32), a lower bottom edge of the sound guiding upper cover (33) abuts against a first step (3211) on an inner wall of the connecting groove (321), a charging post (23) of the mainboard (20) penetrates through a through hole (b) of a baffle (322) of the sealing connector (32); an upper end of a first hollow cylinder (311) of a sound conducting component (31) is inserted into the connecting groove (321) of the sealing connector (32) until a first locking position (3111) abutting against a second step (3311) of the sound guiding upper cover (33) to reserve a gap (323) with a certain distance between the baffle (322) and a platform surface (313); the sound conducting component (31), the sealing connector (32), and the sound guiding upper cover (33) are connected to form the sound guiding and reverberation component (30), wherein the first hollow cylinder (311) of the sound conducting component (31), the connecting groove (321) of the sealing connector (32), and the interior of the second hollow cylinder (331) of the sound guiding upper cover (33) are connected to form the sound transmission channel (34).

The formation of the sealed cavity (103) of the present disclosure:

The housing (10) includes a surface cover (11) and the back shell (12), a front position of the surface cover (11) and a front position of the back shell (12) are respectively provided with a corresponding first circular through hole (c) which directly faces the second circular through hole (a) provided on the front position (20-1) of the mainboard (20); the mainboard (20) is assembled in the back shell (12) of the housing (10); a locking edge (333) of the sound guiding upper cover (33) abuts against an inner edge of a second circular through hole (11-c) of the surface cover (11), and the second arc-shaped opening (332) is located at the second circular through hole (11-c) of the surface cover (11); an outer edge of a lower end surface of the platform surface (313) of the sound conducting component (31) abuts against an inner edge of a second circular through hole (12-c) of the back shell (12), the sound outlet holes (314) located on the first arc-shaped opening (312) are located at the second circular through hole (12-c) of the back shell (12); a charging post (20) of the mainboard (20) penetrates through the through hole (c) of the baffle (322) of the sealing connector (32) and extends into a small through hole (d) of the back shell so that a space below the rear position (20-2) of the mainboard is upward blocked by the mainboard, rightward blocked by the sound guiding and reverberation component (30), downward blocked by the back shell (12), and leftward blocked by a left inner wall of the back shell (12), thereby forming the sealed cavity (103) in the space. The loudspeaker (40) is provided below the rear position (20-2) of the mainboard and located in the sealed cavity (103).

The working principle of the present disclosure:

### 1. The Direction of Original Sound Waves Emitted by the Loudspeaker:

After receiving the information, the pre-programmed procedures on the mainboard controls the loudspeaker to emit sound:

The loudspeaker is disposed in the sealed cavity, so that the original sound waves emitted by the loudspeaker can only propagate and flow within the sealed cavity. First, the sound waves propagate in the direction directly in front, i.e., towards the back shell. After being blocked by the back shell, the sound waves propagate in the opposite direction towards the mainboard and the baffle, and are also blocked by the mainboard and the baffle. The sound waves are rightward blocked by the sound guiding and reverberation component and leftward blocked by the inner wall of the back shell, forcing the sound waves to propagate only towards the reserve gap, and finally flow out from the sound outlet holes on the platform surface below the gap.

### 2. Formation of Reverberant Sound Waves:

When the Bluetooth earphone is worn, the annularly arranged sound outlet holes at the front position are located at the opening of the ear canal, and the sound transmission channel directly faces the opening of the ear canal;

The original sound waves emitted by the loudspeaker flow out from the sound outlet holes. The outer end surface of the sound outlet holes of the sound guiding and reverberation component and the arc-shaped opening are simultaneously set into an arc shape. Multiple original sound waves emitted from the multiple sound outlet holes arranged in a ring shape propagate in multiple directions. When reaching the corresponding symmetrical surface, the sound waves are reflected. The original sound waves can undergo multiple reflections in the sound transmission channel and mix with the air flowing in the sound transmission channel. The original sound waves are superimposed multiple times in the air, thus forming reverberant sound waves. The reverberant sound waves enter the ear canal, and the user hears the sound. Meanwhile, the sound outlet holes evenly arranged in a ring shape at the arc-shaped opening ensure that the original sound waves are emitted evenly, which is more conducive to improving sound quality and listening experience. The hollow interior of the through sound transmission channel makes the ear canal more breathable, while allowing external sounds to be heard, improving the user's reception and discrimination of external situations.

The reason why sound waves superimpose as they propagate through the air:

Utilizing the superposition property of sound waves, when two or more sound wave signals propagate simultaneously in the same medium, each wave maintains its own propagation pattern without interfering with the others. In the overlapping region of the waves, the physical quantity of vibration at each point is equal to the vector sum of the physical quantities caused by each wave at that point, resulting in the superposition of sound waves and the generation of a new waveform. Multiple sound outlet holes arranged in a ring shape in the sound conducting component can generate multiple sound waves, which mix and superimpose with the air within the sound transmission channel to form mixed sound waves. This is the well-known physical principle, which is not repeated in the present disclosure.

The above description is merely a preferred embodiment of the present disclosure, and the specific embodiments described above are not intended to limit the present disclosure. Various modifications and variations can be made within the scope of the technical concept of the present disclosure. All refinements, modifications, or equivalent substitutions made by those skilled in the art based on the above description are within the scope of protection of the present disclosure.

What is claimed is:

1. A sound guiding and reverberation component for a rear loudspeaker of a Bluetooth earphone, comprising a Bluetooth earphone body, a mainboard, a sound guiding and reverberation component, and a loudspeaker being provided inside a housing of the Bluetooth earphone body; wherein the sound guiding and reverberation component penetrates through a first circular through hole (a) in a front position of the mainboard and is disposed at a front position of the Bluetooth earphone body in a penetration manner, the sound guiding and reverberation component is provided with an internally hollow and communicated sound transmission channel, the sound transmission channel located on a side of a back shell of the housing is provided with annularly arranged sound outlet holes which are evenly distributed in a ring shape; a sealed cavity is formed in a space between the sound guiding and reverberation component and a position below a rear position of the mainboard and the back shell; the loudspeaker is located in the sealed cavity and electrically connected to the mainboard; in a wearing state, the sound outlet holes of the sound guiding and reverberation component located at the front position of the Bluetooth earphone body surround an opening of an ear canal, the sound transmission channel located in the middle directly faces the opening of the ear canal, and the loudspeaker located at a rear position of the Bluetooth earphone body is located at an auricle above the opening of the ear canal;
the sound guiding and reverberation component includes a sound conducting component, a sealing connector, and a sound guiding upper cover;
the sound conducting component is a first hollow cylinder with a hollow interior, a lower end surface of the first hollow cylinder is set as a first arc-shaped opening, a platform surface protrudes around a back surface of the first arc-shaped opening, a plurality of sound outlet holes arranged in a ring shape evenly penetrating through the first arc-shaped opening are disposed on the platform surface, an outer end surface of the sound outlet holes is located on an arc surface of the first arc-shaped opening and set in an arc shape; an upper end of the first hollow cylinder is provided with a first inwardly inclined locking position;
the sealing connector is a hollow cylindrical connecting groove, a baffle is provided at a lower end of the connecting groove, and a C-shaped opening is provided on one side of the baffle, corresponding through holes are provided on two sides of the C-shaped opening, and a first step protruding upward in a full circle is provided on an inner wall of the connecting groove;
the sound guiding upper cover is a second hollow cylinder with a hollow interior, an upper end surface of the second hollow cylinder is set as a second arc-shaped opening, and a back surface of the second arc-shaped opening is provided with a locking edge protruding in a full circle; and a second step protruding downward is provided in a cylinder at a lower end of the sound guiding upper cover;
the first circular through hole penetrating through the front position of the mainboard and located at the lower end of the second hollow cylinder of the sound guiding upper cover extends into the connecting groove of the sealing connector, a lower bottom edge of the sound guiding upper cover abuts against the first step on the inner wall of the connecting groove, a charging post of the mainboard penetrates through a through hole of the baffle of the sealing connector; an upper end of the first hollow cylinder of the sound conducting component is inserted into the connecting groove of the sealing connector until the first locking position abutting against the second step of the sound guiding upper cover; a gap with a certain distance is reserved between the baffle and the platform surface; the sound conducting component, the sealing connector, and the sound guiding upper cover are connected to form the sound guiding and reverberation component, wherein the first hollow cylinder, the connecting groove, and the interior of the second hollow cylinder are connected to form the sound transmission channel;
the housing includes a surface cover and the back shell, a front position of the surface cover and a front position of the back shell are respectively provided with a corresponding second circular through hole which directly faces the first circular through hole provided on the front position of the mainboard; the mainboard is assembled in the back shell of the housing; the locking edge of the sound guiding upper cover abuts against an inner edge of a second circular through hole of the surface cover, and the second arc-shaped opening is located at the second circular through hole of the surface cover; an outer edge of a lower end surface of the platform surface of the sound conducting component abuts against an inner edge of a second circular through hole of the back shell, the sound outlet holes located on the first arc-shaped opening are located at the second circular through hole of the back shell; the sealed cavity is formed in the space between the sound guiding and reverberation component and the position below the rear position of the mainboard and the back shell, the loudspeaker is located in the sealed cavity, and an edge of the loudspeaker is inserted into the C-shaped opening of the sealing connector and tightly attached.

2. The sound guiding and reverberation component according to claim 1, wherein the mainboard is provided with pre-programmed procedures and electronic components.

3. The sound guiding and reverberation component according to claim 1, wherein the back shell is provided with two small through holes which directly face the through holes of the baffle, and the charging post on the mainboard extends out; the back shell is provided with a locking post configured to fix the mainboard during mounting; the back shell and the surface cover are provided with corresponding locking positions configured to fix the back shell and the surface cover in the locking positions.

4. The sound guiding and reverberation component according to claim 1, wherein the housing is connected to a battery terminal through a flexible rubber ear hook, the battery terminal is provided with a battery, and the battery is electrically connected to the mainboard through a connecting wire in the flexible rubber ear hook.

5. The sound guiding and reverberation component according to claim 4, wherein an air inlet is provided on one side of the surface cover of the housing, and microphone pickup holes are provided on two sides, respectively.
